(19) United States
(12) Patent Application Publication
(10) Pub. No.: US 2008/0266444 A1
(43) Pub. Date: Oct. 30, 2008

(54) Method, apparatus, and system for continuous autofocusing

(75) Inventor: Dmitri Jerdev, South Pasadena, CA (US)

Correspondence Address: DICKSTEIN SHAPIRO LLP, 1825 EYE STREET, NW, WASHINGTON, DC, 20006, US

(73) Assignee: MICRON TECHNOLOGY, INC.

(21) Appl. No.: 11/790,839

(22) Filed: Apr. 27, 2007

(51) Int. Cl. H04N 5/232

(52) U.S. Cl. 348/345; 348/E05.045

(57) ABSTRACT

A method, apparatus, and system for continuously focusing an imaging device in a video mode is disclosed. An autofocus process is used to adjust the distance between an image sensor and a lens in the imaging device based on one or more hidden frames that are not output as part of the video frame output. The hidden frames can have a smaller resolution than the output frames and can be captured under different conditions than the video output frames.

### FIELD OF THE INVENTION

Embodiments of the invention relate generally to imaging systems and more particularly to a method, apparatus, and system for autofocusing an imaging system.

### BACKGROUND OF THE INVENTION

A desirable feature in video imaging systems, such as digital video cameras, is the ability to continuously autofocus. Continuous autofocus is the ability of the camera to continuously maintain correct focus on a subject even if the camera or the subject moves.

FIG. 1 is a diagram illustrating one example of a conventional video imaging system 100. Specifically, FIG. 1 shows a hand held digital camera having a mode for capturing video. Although the video imaging system shown in FIG. 1 is a hand held digital camera which has a continuous video mode, the teachings of this application apply to any type of video imaging system employing an imager, including, but not limited to, camera systems, scanners, machine vision systems, vehicle navigation systems, video phones, surveillance systems, star tracker systems, motion detection systems, and image stabilization systems.

System 100 typically includes a lens 170 for focusing images on an imager 120. System 100 generally also comprises a central processing unit (CPU) 150, such as a microprocessor, that communicates with an input/output (I/O) device 130 over a bus 110. The imager 120 also communicates with the CPU 150 over the bus 110. The system 100 also includes random access memory (RAM) 160, and can include removable memory 140, such as flash memory, which also communicates with the CPU 150 over the bus 110. The imager 120 may be combined with the CPU 150, with or without memory storage, on a single integrated circuit or on a different chip.

FIG. 2 is a diagram showing a portion 200 of system 100. Portion 200 shows the lens 170 mounted in an adjustable lens mount 220 over imager 120 receiving an image 210. Imager 120 may be constructed as a system on a chip imager, which includes a pixel array and pixel processing circuitry. The distance from lens 170 to a focus point 240 on imager 120 is a focal length f. Adjusting the position of the lens 170 relative to the imager 120 changes the focal length f and focus characteristics. Thus, the focal length f₁, which is the distance from M1 to M2, may be changed to f₁′ when lens 170 is adjusted from position B to position A to bring a desired object within an image into focus on the imager 120.

A processing circuit 260, which could be implemented as a separate hardware circuit, programmed processor or implemented as part of an image processing circuit employed in imager 120, receives successive captured image frames 250 from a pixel array of imager 120. The processing circuit 260 analyzes the received frames to adjust the distance between the lens 170 and the imager 120 to bring into focus images captured by the system 100. Processing circuit 260 could use any auto-focusing technique, including techniques that consider more than one previously captured image, techniques that analyze a frame to determine pixels that represent the subject of the frame, and techniques that attempt to predict future autofocus moves from previous autofocus moves. More specific details of such lens adjustment methods and apparatuses are described in U.S. Patent Application Publication Nos. 2006/0012836 and 2007/0009248 and U.S. patent application Ser. Nos. 11/354,126 and 11/486,069, all of which are hereby incorporated herein by reference.

For example, one well known method of auto focusing involves analyzing differences in sharpness between image objects in a frame and determining a sharpness score. By applying such a method to a first received frame, processing circuit 260 might determine that the system 100 is out of focus then step lens 170 from position B to position A. Processing circuit 260 could then analyze a second frame then determine to step lens 170 back to position B, to allow lens 170 to remain at position A, or to step lens 170 to a position C not shown in FIG. 2.

FIG. 3 illustrates an exemplary imager 120 which could be employed in the FIG. 1 system. Although FIG. 3 illustrates a CMOS imager, imager 120 could be implemented using CCD or any other type of imaging technology. Imager 120 has a pixel array 302 connected to column sample and hold (S/H) circuitry 336. The pixel array 302 comprises a plurality of pixels 320 arranged in a predetermined number of rows and columns. A plurality of row and column lines are provided for the entire array 302. The row lines e.g., SEL(0) are selectively activated by row decoder 330 and driver circuitry 332 in response to an applied row address to apply pixel operating row signals. Column select lines (not shown) are selectively activated in response to an applied column address by column circuitry that includes column decoder 334. Thus, row and column addresses are provided for each pixel 320.

The CMOS imager 120 is operated by a sensor control and image processing circuit 350. Circuit 350 controls the row and column circuitry for selecting the appropriate row and column lines for pixel readout, outputs pixel data to other components of system 100, and could perform other processing functions. As is well known in the art, the functions of sensor control and image processing circuitry 350, processing circuit 260, and CPU 150, could be implemented as separate components or could be implemented as a single signal processing circuit located anywhere in system 100.

As noted, system 100 can be operated in a video mode in which successive image frames are captured at a predetermined capture rate. In this mode, imager 120 automatically stores or outputs a series of captured frames. This series of frames corresponds to a digital video which can be stored in the memory 140 of the system or output from system 100. The same output frames are also used for performing an autofocus operation on a next-acquired frame in order to perform a continuous autofocus operation. However, unlike a non-video digital image capture where successive image frames are analyzed in an autofocus operation before an output image is captured, in a video stream all captured images are output, which reduces the frames available for an autofocus operation. Consequently, it is often difficult when performing such an autofocus operation on a video output frame stream to keep an image in focus, resulting in out of focus images in the output video stream.

### BRIEF DESCRIPTION OF THE DRAWINGS

FIG. 1 illustrates a video imaging system.

FIG. 2 illustrates a portion of the video imaging system shown in FIG. 1.

FIG. 3 illustrates an imager that could be used in the video imaging system shown in FIG. 1.

FIGS. 4 and 5 illustrate an embodiment of a method for continuously autofocusing a video imaging system.

FIGS. 6 and 7 illustrate another embodiment of a method for continuously autofocusing a video imaging system.

FIG. 8 illustrates another embodiment of a method for continuously autofocusing a video imaging system.

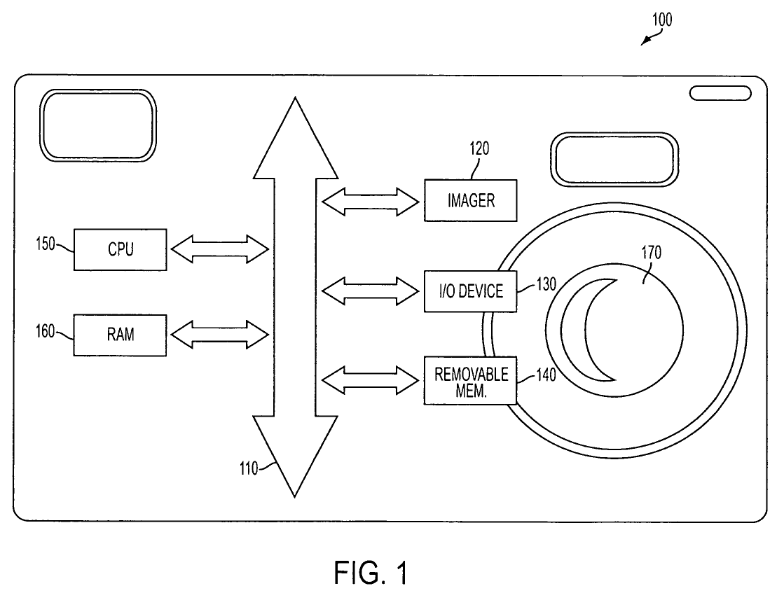

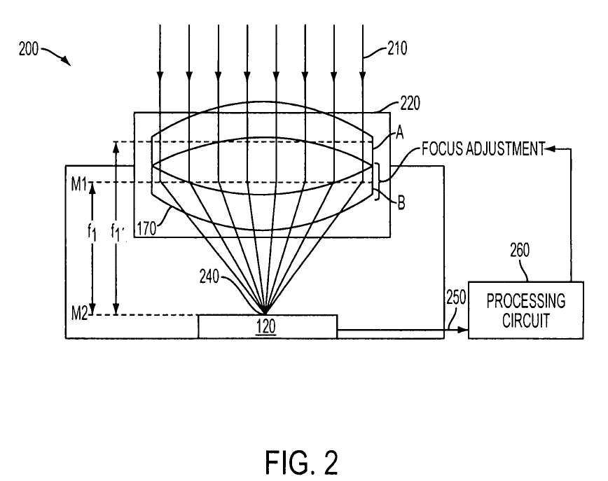

### DETAILED DESCRIPTION OF THE INVENTION

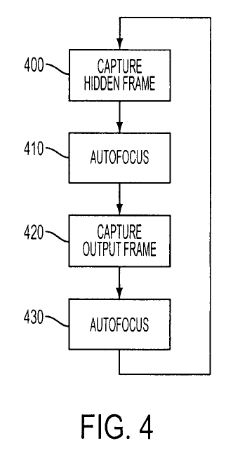

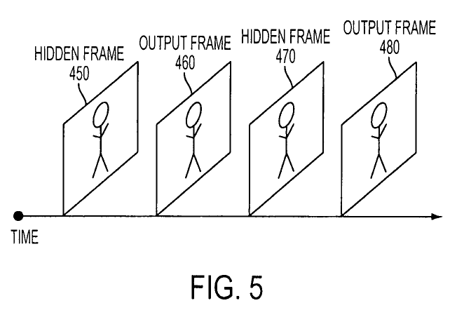

Embodiments disclosed herein provide a system 100 which has a continuous autofocus operation in the video mode with an improved focusing operation by using additional “hidden frames” which are acquired and used for autofocus operations, but which are not output as part of the video output frame stream. FIGS. 4 and 5 illustrate a first embodiment of a method for continuously autofocusing system 100.

First, at step 400 the system 100 operates imager 120 to capture a “hidden frame” 450. Frame 450 is referred to as a “hidden frame” because is not output as part of the video output frame stream or otherwise accessible to a user, and does not get output to a user through I/O device 130 or stored to a removable memory 140. Hidden frame 450 is used by system 100 for autofocus processing purposes, though it could also be used for other image acquisition functions as well. After system 100 completes processing functions requiring hidden frame 450, including auto focus, system 100 could overwrite or delete the hidden frame 450. The hidden frame could also be used for other processing functions, and it is possible for system 100 to perform auto focusing operations using only hidden frames 450. Moreover, while capturing and processing hidden frames, system 100 could disable signals used to control the output of frame data to users.

Step 410 of FIG. 4 is an example of an autofocus function performed using hidden frame 450. At step 410, system 100 performs an autofocus operation using a hidden frame 450. Specifically, the system 100, using any of its various processing capabilities, and using any known autofocusing method, performs an autofocus function to adjust the distance between lens 170 and imager 120. For example, a processing circuit 260 could adjust the distance between lens 170 and imager 120 by analyzing sharpness characteristics of the acquired hidden frame 450.

At step 420, system 100 captures an “output frame” 460. Unlike hidden frame 450, an output frame 460 is intended to be output and is otherwise available to a user. For example, output frame 460 may be output from the system 100 using I/O device 130, displayed on a video screen associated with system 100, or stored to removable memory 140. Thus, an output frame 460 and a hidden frame 450 differ in that the output frame 460 is available to a user of system 100 in some manner while a hidden frame 450 is internal to system 100 and is not available to a user under normal operations of system 100.

After capturing an output frame 460, system 100, at step 430, can perform an autofocusing or other processing function using the output frame. For example, step 430 could use the same autofocusing algorithm used during step 410 or could use different autofocus algorithms. Further, the processing performed at step 430 could use output frame 460 or, depending on the specific processing function performed, use previously captured hidden frames or output frames for an autofocus operation. System 100 repeats steps 400, 410, 420, and 430 in order to capture an additional hidden frame 470, an output frame 480, and subsequent hidden and output frames. Again, output frames, such as frames 460 and 480, will be available to a user in some way, while hidden frames, such as frames 450 and 470, will not be available to a user through normal operation of system 100. FIG. 5 shows how the hidden frames and output frames are interleaved as part of the image capture process.

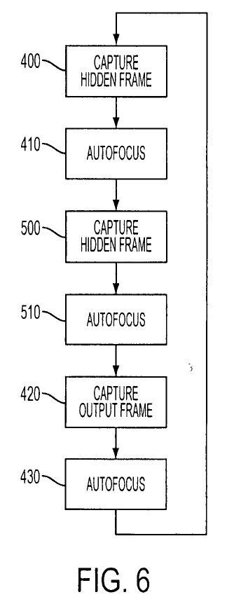

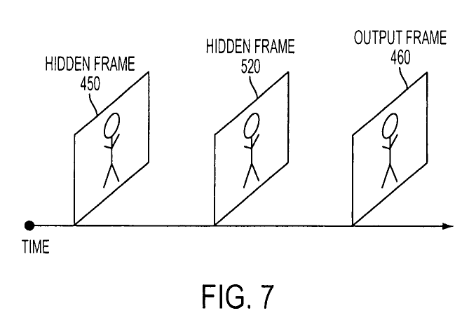

System 100 can capture and use multiple hidden frames 450, 470 between output frames. FIGS. 6 and 7 illustrate an example of such an embodiment. FIGS. 6 and 7 are similar to FIGS. 4 and 5, except that FIG. 6 includes steps 500 and 510 and FIG. 7 includes an additional hidden frame 520. First, as previously explained, at steps 400 and 410 system 100 captures a hidden frame 450 then autofocuses based on hidden frame 450. Next, at steps 500 and 510, system 100 captures another hidden frame 520 then autofocuses based on at least hidden frame 520. Thus, in this embodiment, before capturing output frame 460, system 100 has autofocused its lens system based on two frames: hidden frame 450 and hidden frame 520.

Increasing the number of captured hidden frames and autofocusing operations improves the autofocusing function of system 100 and helps ensure that the output frames are in focus. Thus, the more hidden frames system 100 captured and used in autofocusing, the better focused the output frames. Although the FIGS. 4 and 6 embodiments use the output frame for autofocus, it is possible to configure system 100 so that autofocus is performed using only hidden frames in which case step 430 of FIG. 4 and FIG. 6 can be omitted. While increasing the number of hidden frames improves autofocusing performance, it also taxes the processing capabilities of system 100. Thus, the number of hidden frames captured and used for autofocus needs to be balanced against the available processing capabilities of the autofocus processing circuit 260. The processing circuit 260 may be constructed as a hardware electronic circuit, a programmed processor, or a combination of the two. In addition, the processing circuit 260 could be part of processing circuit 350 of imager 120 used for sensor control and image processing operations. The processing circuit 260 may also be part of the CPU 150, which controls camera operations.

In a modified embodiment, system 100 does not need to capture hidden frames with the same resolution as output frames. It has been determined that system 100 can perform adequate autofocusing processing using hidden frames which have a resolution as small as 5% to 10% of the resolution of output frames which reduces the load on the autofocus processing capabilities of system 100.

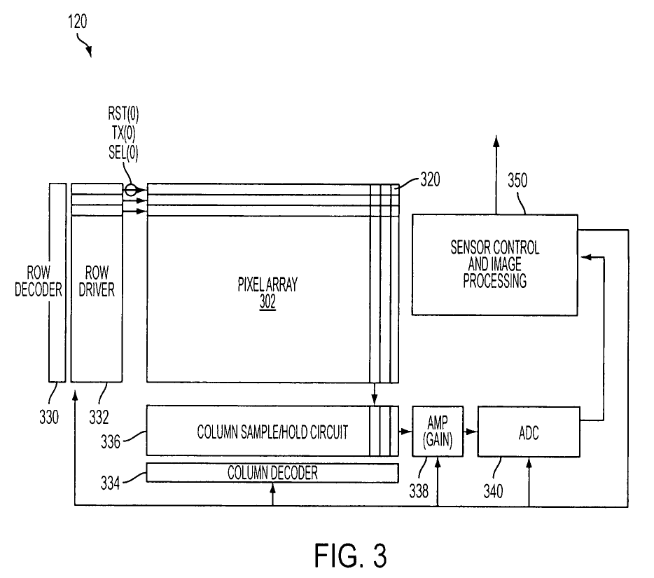

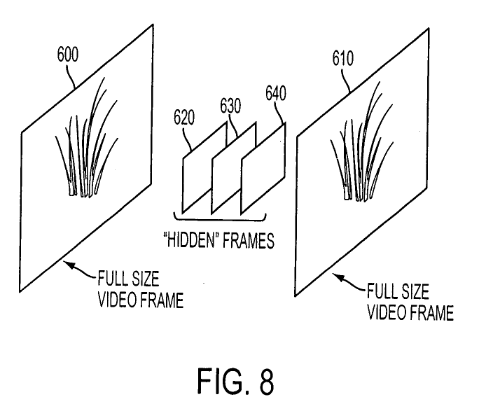

FIG. 8 diagrammatically illustrates the operation of system 100 using three reduced resolution hidden frames between successive higher resolution output frames 600, 610. Thus, frames 600, 610 can be captured using the full resolution of pixel array 302 shown in FIG. 3, while hidden frames 620, 630, and 640 used for autofocusing are captured using pixels corresponding to a reduced area of the pixel array 302. The exact pixels used to capture reduced resolution hidden frames can be adaptively determined according to well-known subject-finding algorithms. For example, while performing an autofocusing step based on an output frame, such as step 430 of FIG. 4, system 100 could determine the location of the main subject of frame 600. In this case, system 100 could then capture a reduced resolution frame by instructing imager 120 to collect image data from only pixels of the pixel array receiving light from the area of the frame corresponding to the location of the main subject of the frame. Other alternative technologies, such as pixel binning, where signals from adjacent pixels are combined to reduce image resolution could also be used to lower the resolution of the hidden frames and thus reduce the processing load on the processing circuit executing the autofocus algorithm.

In addition to having a lower resolution compared to output frames, hidden frames could also be captured using a different integration time than the integration time used when capturing an output frame. As is well known in the art, integration time refers to the time period during which a pixel acquires an image signal. Referring back to FIG. 4, when capturing an output frame at step 420, system 100 could operate the pixel array of imager 120 using a first integration time. Then during step 430, system 100 could reconfigure the parameters used to capture frames so that at step 400 system 100 operates the pixel array of imager 120 to capture images using a second integration time. This second integration time could be shorter than the first integration time.

System 100 could also apply a different gain to signals of the pixel array when capturing hidden frames than the gain applied to the pixel signals for output frames. For example, as shown in FIG. 3, amplifier 338 applies a gain to signals read from pixels in the pixel array 302. When reading pixel signals for an output frame at step 420, system 100 could apply a first gain to the signals read from the pixels, while when reading pixel signals for a hidden frame at 400, system 100 could apply a second gain to the signals read from the pixels, as instructed by the sensor control and image processing circuit 350. System 100 could change the gain at steps 410 and 430.

The use of different integration times and gains for hidden frames and an output frame could also be combined in another embodiment. For example, system 100 could capture hidden frames using a shorter integration time than that used for output frames, while using a higher gain than the gain used for output frames.

In other embodiments, system 100 could process hidden frames differently from the way system 100 processes output frames. For example, when capturing and outputting output frames, it is well known to use various processing techniques, including binning and scaling. Such processing techniques could be disabled at step 430 before system 100 captures and processes hidden frames. Additionally, binning and scaling could be used on the hidden frames to lower resolution, but not used on the output frames.

In order to capture and process the hidden frames, system 100 should capture frames at a frame rate greater than the frame rate normally used for video capture. For example, consider a system 100 configured to capture and process one hidden frame for each output frame, and assuming that capturing and processing the hidden frame consumes the same amount of time as capturing and processing the output frame, then for an output video frame rate of 30 frames per second (“fps”), system 100 should have the capability of capturing frames at 60 frames per second (fps).

Various factors determine the difference between the user defined frame rate and the actual frame rate system 100 would use. For example, increasing the number of hidden frames captured between each output frame would increase the rate at which system 100 would have to capture images in order to output a video stream corresponding to the user defined frame rate. However, increasing the number of hidden frames also improves the performance of the auto focusing functions. On the other hand, decreasing the integration time for the hidden frames, decreasing the resolution of the hidden frames, or deactivating processing of hidden frames would reduce the frame rate at which system 100 is required to capture images.

The above description and drawings illustrate embodiments that achieve the objects, features, and advantages of the present invention. However, it is not intended that the present invention be strictly limited to the above-described and illustrated embodiments. Any modification, though presently unforeseeable, of the present invention that comes within the spirit and scope of the following claims should be considered part of the present invention.

What is claimed as new and desired to be protected by Letters Patent of the United States is:

1. A method of operating an imaging device to provide a video output signal, said method comprising:
acquiring a first image frame which does not form part of said video output signal;
performing an autofocus operation using said first image frame;
acquiring a second image frame;
outputting the second image frame from the imaging device as part of the video output signal; and
repeating the acts of acquiring the first image frame, performing the autofocus operation, and acquiring and outputting the second image frame to provide said video output signal.

2. A method of claim 1, further comprising:
performing an autofocus operation using said second image frame.

3. A method as in claim 2, wherein:
said first frame and second frame are acquired in an interleaved fashion.

4. A method as in claim 1, further comprising:
acquiring a third image frame which does not form part of said video output signal;
performing an autofocus operation using said third image frame, wherein:
said acts of acquiring said third image frame and performing said autofocus operation using said third image frame are repeated and are performed between the act of performing an autofocus operation using said first image frame and the act of acquiring said second image frame.

5. A method as in claim 4, further comprising:
performing an autofocus operation using said second image frames.

6. A method as in claim 1, wherein:
said first image frame is acquired under different acquisition conditions than those used to acquire said second image frame.

7. A method as in claim 6, wherein:
said first image is acquired using a shorter image integration period than the image integration period used to acquire said second image frame.

8. A method as in claim 6, further comprising:
applying a gain to the pixel signal of said first image frame and said second image frame,
wherein the gain applied to the pixel signals of said first image frame is different from the gain applied to the pixel signals of said second image frame.

9. A method as in claim 8, wherein:
said first image is acquired using a shorter image integration period than the image integration period used to acquire said second image frame; and
the gain applied to the pixel signals of said first image frame is greater than the gain applied to the pixel signals of said second image frame.

10. A method as in claim 1, wherein:
said first image frame has a lower image resolution than said second image frame.

11. A method as in claim 10, wherein:
the size of the imaged area in said first image frame is smaller than the size of the imaged area in said second image frame.

12. The method of claim 11, wherein:
the imaged area of said first image is determined by performing an object finding process on a full size image frame.

13. A method as in claim 10, wherein:
the resolution of said first image frame is in the range of about 5 to about 10 percent of the resolution of the second image frame.

14. An imaging device capable of providing a video output signal comprising:
a processing circuit configured to:
acquire a first image frame which does not form part of said video output signal;
perform an autofocus operation using said first image frame;
acquire a second image frame;
output the second image frame from the imaging device as part of the video output signal; and
repeat the acquiring the first image frame, performing the autofocus operation, and acquiring and outputting the second image frame to provide said video output signal.

15. The imaging device of claim 14, wherein:
said processing circuit is also configured to perform an autofocus operation using said second image frame.

16. The imaging device of claim 15, wherein:
said processing circuit is also configured to acquire the first frame and the second frame in an interleaved fashion.

17. The imaging device of claim 14, wherein:
said processing circuit is also configured to:
acquire a third image frame which does not form part of said video output signal;
perform an autofocus operation using said third image frame; and
repeat said acquiring said third image frame and said performing said autofocus operation using said third image frame between the performing an autofocus operation using said first image frame and the acquiring said second image frame.

18. The imaging device of claim 17, wherein:
said processing circuit is also configured to perform an autofocus operation using said second image frame.

19. The imaging device of claim 14, wherein:
said processing circuit is also configured to acquire said first image frame under different acquisition conditions than those used to acquire said second image frame.

20. The imaging device of claim 19, wherein:
said processing circuit is also configured to acquire said first image using a shorter image integration period than the image integration period used to acquire said second image frame.

21. The imaging device of claim 19, further comprising:
circuitry configured to apply a gain to the pixel signals of said first image frame and said second image frame, wherein the gain applied to the pixel signals of said first image frame is different from the gain applied to the pixel signals of said second image frame.

22. The imaging device of claim 21, wherein:
said processing circuit is also configured to acquire said first image using a shorter image integration period than the image integration period used to acquire said second image frame; and
said circuitry is also configured to apply a greater gain to the pixel signals of said first image frame than the gain applied to the pixel signals of said second image frame.

23. The imaging device of claim 14, wherein:
said processing circuit is also configured to acquire said first image frame so that said first image frame has a lower image resolution than said second image frame.

24. The imaging device of claim 23, wherein:
said processing circuit is also configured to acquire said first image frame and said second image frame so that the size of the imaged area in said first image frame is smaller than the size of the imaged area in said second image frame.

25. The imaging device of claim 24, wherein:
the processing circuit is also configured to determine the imaged area of said first image by performing an object finding process on a full size image frame.

26. The imaging device of claim 14, wherein:
the processing circuit is also configured to acquire said first image frame so that the resolution of said first image frame is in the range of about 5 to about 10 percent of the resolution of the second image frame.
